(19) United States
(12) Patent Application Publication
(10) Pub. No.: US 2014/0340490 A1
(43) Pub. Date: Nov. 20, 2014

(54) PORTABLE SIMULATED 3D PROJECTION APPARATUS

(71) Applicants: Paul Duffy, Toronto (CA); Hagan Carlile, Toronto (CA); Ye Zhen Liang, Toronto (CA); Zoran Vranjes, Mississauga (CA)

(72) Inventors: Paul Duffy, Toronto (CA); Hagan Carlile, Toronto (CA); Ye Zhen Liang, Toronto (CA); Zoran Vranjes, Mississauga (CA)

(21) Appl. No.: 13/894,904

(22) Filed: May 15, 2013

(51) Int. Cl. G02B 27/22; H04N 13/04

(52) U.S. Cl. CPC G02B 27/2278; H04N 13/0459
USPC 348/51; 353/10

(57) ABSTRACT

A projection apparatus is provided which is portable and scalable in size, and comprises a first projection device to direct a first program material towards a planar viewing film which is at least partially transparent and at least partially reflective, and which is mounted at an angle with respect to the viewing plane of a viewer, so as to create a virtual image. A rear screen is arranged in the viewing plane, behind the viewing film so as to exhibit second program material from a second projection device. The first program material and the second program material are edited and synchronized one with the other so that the virtual image is interrelated with the second program material on the rear screen, and provide an enhanced simulated 3D viewing.

### FIELD OF THE INVENTION

This invention relates to projection apparatus, and in particular the invention relates to a projection apparatus which is portable and scalable, and which is used in a manner so that a viewer will see a video presentation which comprises a simulated, virtual image which is seen against a background which background may contain a further image which varies in a programmed manner in keeping with the actions being portrayed by the virtual image. Preferably, the present invention relates to apparatus and devices which may be employed in theatrical, educational, or medical presentations, for example, and more particularly in presentations which are intended to promote and/or extol the features and advantages of any product or service being offered for sale.

### BACKGROUND OF THE INVENTION

The present invention finds its genesis in an theatrical illusion which is widely known as “Pepper's ghost”. In this illusion, a viewer is made to believe that he is seeing an article which does not, in fact, exist in the setting or circumstances being viewed. The techniques involved in presenting Pepper's ghost are described hereafter. However, for now, a brief description and history of Pepper's ghost is provided.

In order for the Pepper's ghost illusion to work properly, the viewer must see clearly into a main setting, but not see into a hidden room. Unknown to the viewer, the viewer is also viewing the main setting through an angled piece of glass which, because of its placement, can be both translucent and reflective. By changing the lighting in the hidden room, the viewer can view a reflection of the lit contents of the hidden room, on the glass panel. Thus, the illusion is controlled by its illumination, and will appear and disappear when the lighting of the object, person, or the like, is turned on or off, respectively. As a result, an object or person which is reflected in the “mirror” section of the glass (e.g. the reflective surface of the glass) may seem to appear or disappear, or change into another object. While this illusion is over 100 years old, the same effect has been employed since at least the 1960's in certain modern theme parks, where objects such as reflected animated props can create the appearance of three dimensional, translucent “ghosts” which appear to be moving through a particular setting and interacting with props in that physical particular setting.

Typically, in recent applications, a polymeric film, drawn tight within a metal frame, is used to replace the glass panel. While important to the presentations provided by the present inventions, construction of the film and associated frame, is well known in the art, and outside of the scope of the present invention.

As the term “mirror” is used herein with respect to glass or film used in the present invention, it is meant to mean any reflective surface that will reflect a portion of the light which impinges upon it. Usually, in the context of the present invention, that means that about 50%, and perhaps as much as 80%, of the light impinging upon the surface of the mirror, from the hidden room, is reflected therefrom.

Current uses on this technique also include the simultaneous presentation of a speech to numerous groups in many different locations, using a virtual image. Other applications include providing a virtual performance by a performer, even though the performer is no longer alive. However, it should be noted that during these presentations, it was necessary to employ a black background surface behind the virtual image so as to avoid any background image showing through the virtual image. Indeed, that is almost always the case because otherwise a background could be seen through the virtual image, thereby destroying the effect of the three dimensional “holographic” image “floating” before a dark background—i.e., in a dark void.

It must be stressed though, that the present technique provides a virtual image which provides a simulation of a three dimensional (3D) object, and thereby acts to simulate (to a certain extent) a holographic image. It must be noted that the entertainment and promotional industries, and television and video in particular, very often refer to the images which are being viewed as being holographic, and that term is used herein. However, such images as are being discussed herein are, strictly speaking, planar, but when used together, can provide the illusion of a 3D image.

To return to the Pepper's ghost technique, it is employed in 3D displays which are typically referred to as holographic; and in fact, when a true Pepper's ghost illusion is manifested, the reflection is that of a three dimensional physical object or person which is located offstage and is seen reflected in the mirror. In modern days, however, the source object is typically replaced with a digital screen such as a television screen or television or digital projector, which displays imagery onto a frame mounted transparent/translucent film. The imagery can be generated with 3D computer graphics so as to provide the necessary depth cues for the viewer. However, the reflection, which seems to float in midair, is in fact flat, so that the illusion may be somewhat less realistic than if an actual 3D object was being reflected.

It is thus possible to create a fairly simple illusion by directing images onto angled semi-transparent screens, so that at least part of the image is reflected back towards a viewer, and thus create a virtual image in the viewing plane of the viewer. Typically, the images are directed towards the film using some type of image projector. Further, the images can be reflected through actual mirrors on to a focus screen, in such a manner that the image will be directed towards the glass or film, in such a manner that projection of the image onto the background surface is avoided. Otherwise, the semi-transparency of the screen could allow the background, rear screen to also be illuminated by the projection, which would of course destroy the illusion of the virtual image.

The present inventors have unexpectedly discovered that the employment of two or more projection devices, such as television projection devices, one of which is used to direct images to an angled, or tilted semi-transparent and semi-reflective film to create a virtual image, and the other providing a rear image on a rear screen behind the tilted semi-transparent and semi-reflective screen, will provide a very real, simulated three dimensional illusion which may be viewed with the naked eye, thereby not requiring any specific eyeglasses, and where the perceived three dimensional image may be seen by a plurality of viewers simultaneously.

To achieve that effect, the inventors herein provide an apparatus which has the ability to deliver real depth perception having multiple planes so as to create advanced visualizations that have been heretofore unavailable in simulated 3D technologies. In particular, the present invention provides a novel combination of new and existing technologies so as to permit visualizations which may employ animated and virtual holographic content with apparent parallax.

A particular achievement by the present inventors is to provide such an apparatus which is preferably both scalable and portable, and which may be moved from one exhibition site to another as a single structure. However, the general techniques for providing 3D visualizations in keeping with the present invention will apply to structures which employ the same principle hardware and software, but which may be more or less permanently installed in such locations or devices such as a theatre, an outdoor display, or television studio.

To that end, and rather than relying on such as hidden rooms and the like, the present invention provides a stage-style viewing experience whereby all of the visualization is perceived to be projected onto the center of the stage. Scalability therefore allows the system to use and reflect whichever light sources are available and suitable for the appropriate application. As such, the present invention can be provided in such differing circumstances as a theatre, or by using a large television set or a small television set, or even a tablet computer.

Use of devices such as television screens, and the like, and frame-mounted films, are now particularly available due to the improvement in providing lightweight, semi-translucent and semi-reflective films, and the availability of television projectors or screens which have much greater brightness and luminosity than previously available.

Accordingly, the present inventors can now provide a visualization apparatus and system which strategically introduces a rear screen so as to induce the perception of parallax between projected holographic and rear images. Moreover, by providing suitable synchronization technology between the holographic image program material which is projected onto the semi-translucent and semi-reflective film, and the recorded program material which is projected onto the rear screen, a more realistic content aspect, such as a motion effect, is achieved than would be produced from a static illuminated rear screen.

It has been noted above that a dark background, typically black, has hitherto been required in modern expressions of holographic imagery, because otherwise a background would be seen through the holographic image. Thus, the perceived image is essentially a 2D image which appears to float on a single viewing plane. However, as noted, the present invention provides for the existence of a rear image as opposed to a dark background, thereby vastly improving not only the imagery being viewed but the nature of the program material which can be provided. The rear screen provides a rear plane which will enhance the overall user perception of three dimensional imagery. Indeed, clever placement of the holographic image in the foreground and proper editing of the background or rear image using such image editing techniques as matting and computer editing will provide a perceptible depth behind the holographic plane and the rear plane, so that the parallax created between those two planes produces a more pronounced simulated 3D experience. Parallax will be discussed in greater detail hereafter.

Still further, it should be noted that there is a transparency value which is associated with any color. For example, the color black is 100% transparent, in terms of projection in keeping with the present invention, whereas the color white is essentially opaque. However, transparency of various colors can result in problematic imagery when multiple planes of visualization are employed. For example, imagery in the background layer—the rear screen—will be revealed in any dark area in the foreground—the viewing film—with the result that the image gives the impression of being “ghostly”. However, these shortcomings can be overcome by controlling the opacity and luminance levels of the projection images, and by using techniques such as providing “traveling mattes” on the rear screen.

To be more specific, adjusting the opacity and luminance values of the background layers—the rear screen—with respect to the foreground layers—the viewing film—will improve the perceived image parallax and the foreground image fidelity. In that regard, it is preferred, but not absolutely essential, that the background opacity should be adjusted to between 20% and 40% of the foreground layer so as to achieve a well perceived three dimensional effect.

The use of traveling mattes may be achieved physically, but in most cases, is done by editing the image content using a computer application. Essentially, a traveling matte is an artificial black mask that is a “cut-out” of the foreground imagery, and which is applied to the corresponding background plane. This results in a significant improvement to the overall effect. Obviously, the masks which are applied to the background imagery are synchronized to, and in traveling time with, the foreground imagery, and are sized so as to approximate the size of the foreground image. Typically, the matte is between 80 and 120% of the size of the foreground image.

Overall, the creation of various content aspects in accordance with the present invention, including, for example, parallax, relative opacity, luminance, travelling mattes, and the like, acts to provide an improved and enhanced simulated 3D experience. In the present invention, this content creation is achieved through editing, synchronizing and/or interrelating the virtual image (or images) to the background image.

### DESCRIPTION OF THE PRIOR ART

U.S. Pat. No. 8,172,400 describes a projection apparatus which requires a first projection device that is arranged to generate a virtual three dimensional object by projection of the image onto to a reflected/translucent polymer film. A second projection device projects a background image; and a light source projects light onto the virtual three dimensional image. For purposes of the viewer, the frequency of the projected light corresponds to the light frequency of the background image. However, the practical examples as taught in the patent provide only for a projector which projects downwardly onto a pigmented reflective board, with the image being redirected from the reflective board to a screen which is typically a polymeric foil, and which has a partially reflective coating on the front face of the foil. A stage arrangement is placed behind the screen, upon which a presenter or actor, or a prop, or both, may be located. That person or prop is illuminated from above by a light source so as to reduce the effect of any residual light which is reflected from the reflective board onto the prop.

The patent also proposes the use of a mask which can be formed on the screen by computer control of the projection screen which projects an image onto the screen.

Finally, the patent proposes that a number of components of the large apparatus which is taught may be tilted or moved in an attempt to enhance the perception of three dimensionality from the projected object.

### SUMMARY OF THE INVENTION

The present invention therefore provides a portable projection apparatus which may be moved from one exhibition site to another, and which is scalable in size from one such apparatus to another. The portable projection apparatus comprises a first projection device arranged to project a virtual image of a program material towards a first, viewing film, whereby the viewer can observe the image, and thus, view the first virtual program material. The viewing film typically has a front face and a back face, and is angularly mounted with respect to the viewer's viewing plane. Also, the viewing film is at least partially transparent and at least partially reflective.

A second, rear screen is also provided which is arranged to exhibit a second image of a second program material from a second projection device. The rear screen is typically substantially vertically oriented with respect to the viewing plane behind the back face of the viewing film.

Additionally, the first virtual program material and the second program material are edited and synchronized one with the other so that holographic images projected towards the viewing film appear to be interrelated to, or merge into, the program material on the rear screen, and so as to provide a 3D viewing experience.

As such, in a first aspect, the present invention provides a portable projection apparatus which may be moved from one exhibition site to another, and which is scalable in size from one such apparatus to another, comprising:

a first projection device arranged to project first program material towards a planar viewing film, wherein said viewing film has a front face and a back face, and is angularly mounted with respect to a viewing plane, and wherein said viewing film is at least partially transparent and at least partially reflective, whereby at least one viewer may view a reflected image of said first program material in said viewing plane, as a virtual image;

a second, rear screen arranged to exhibit second program material from a second projection device, and being oriented with respect to said viewing plane behind the back face of said viewing film;

wherein the first program material and the second program material are edited or synchronized one with the other so that said virtual image appears to be interrelated to said second program material on said rear screen, so as to provide a simulated 3D viewing experience.

The planar viewing film is typical to those films known in the art, and can include metalized films chosen from the group consisting of metalized polyester film and metalized polymer film. The use of other types of films, or even glass, is not excluded however.

The portable projection apparatus of the present invention may comprise at least one projection television apparatus having lamps and projection lenses as the first projector device.

However, more generally the first projection device is chosen from the group consisting of a planar television tube, a planar plasma television display, a planar LCD television display, a planar LED lit LCD television display, and a planar LED television display. Other types of projector devices can also be utilized.

The planar viewing film is typically angled with respect to the viewer. In some cases, the viewing film can be angled to the left or right of the viewer, or can be sloped rearwardly with respect to the viewing plane.

In a preferred arrangement, however, the viewing film is sloped forwardly with respect to the viewing plane, so that images from the floor of the “stage” of the device, are reflected towards the viewer. This arrangement is particularly advantageous in small applications, as will be described hereinbelow.

The angle at which the viewing film is sloped forwardly with respect to the viewing plane is in the range of 30° to 60°. However usually the angle at which the viewing film is sloped forwardly with respect to the viewing plane is in the range of 40° to 50°, and typically, at an angle of about 45°.

The planar viewing film has a reflection factor in the range of 20% to 80%, and a transparency factor in the range of 80% to 20%. The film may also include such features as low flammability, low haze, and the like.

In a preferred arrangement, the present invention contemplates that the rear screen may be provided by the screen of a television apparatus, or monitor. This can include televisions or monitors that are rear projection devices, but more preferably, the rear screen is chosen from the group consisting of a planar television tube, a planar plasma television display, a planar LCD television display, a planar LED lit LCD television display, and a planar LED television display. Other display devices might also be used as the rear screen, and the skilled artisan will be aware that their use is not precluded from the present invention. Moreover, the rear screen can comprise a plurality of devices which are arranged to provide a preferably planar rear surface. For example, 4 devices can be arranged in a planar 2×2 grid. Other arrangements are possible, and these can include 3×3 grids, 4×4 grids, 2×3 grids, 3×2 grids, or any other suitable arrangement.

It will be noted that the images of the first program material and the images of the second program material can be independent. However, in keeping with the present invention, preferably the images of the first program material and the images of the second program material are synchronized. Typically, synchronization of the first program material and the second material is preferably under the control of a computer, or some other computerized device.

The portable projection apparatus of the present invention is preferably arranged so that images from the first program material and/or the second program material are altered or edited, in such a manner so that any chosen image from the first program material which is reflected towards the viewing film, will create a virtual image which will appear to align with an edited area of the second program material presented on the rear screen, when viewed in the viewing plane. In a preferred arrangement, the first program material, as a virtual image, will appear to be superimposed, or in front of, the edited second program material on the rear screen. In one particularly preferred arrangement, the second program material is altered so that no image is provided in the area behind the image provided in the first program material. As such, the first program material image is provided without any image from the second program material being superimposed on, or under, the virtual image.

Still further, the editing and placement of the first program material image and the edited area of the second program material image are such that the chosen virtual image and the edited area of the second program material may be made to move in any direction, relative one to the other, from frame to frame of the virtual image and the second program material image. As such, the directions of movement from frame to frame of the virtual image, and the edited area of the second program material image can be in opposite directions, so as to provide an enhanced illusion of movement one with respect to the other.

It will also be noted that additional films and projection devices can be added, and placed in front of the first viewing film. As such, a plurality of films, and their associated projection devices, can be added to the basic structure. In this manner, the viewer will view tandem images through 2 or more films. Commonly the number of films will be between 1 and 10, and most preferably, the number of films is between 1 and 3. Synchronization of the images moving from film to film, or film to background screen, can be provided by this arrangement.

As such, in a further feature, the present invention also provides a portable projection apparatus as herein described, additionally comprising at least one additional projection device arranged in front of said first projection device, and positioned to project additional program material towards an additional planar viewing film, which is also angularly mounted with respect to a viewing plane, and wherein said viewing film is at least partially transparent and at least partially reflective, whereby at least one viewer may view said additional program material in said viewing plane, when projected onto said additional planar viewing film, as an additional virtual image.

Finally, in a particular embodiment of the present invention, the first and second projection devices, the viewing film, and the rear screen, are permanently mounted in a case so as to be portable as a single structure, as will be hereinafter described. Typically, though, this case will be limited to the size of a television display, and would normally be a box having a length, height and width, of less than about 2.25 m, and more typically, less than 1.5 m. For smaller devices, the box can have length, height and width values which are all less than 40 cm.

For a hand-held device, the box will typically have length, height and width values which are all greater than 5 cm, and more preferably, greater than 10 cm.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a sketch showing the general layout and functioning principles of a prior art Pepper's Ghost installation;

FIG. 2 is a sketch showing the general layout of a large-scale embodiment of the present invention;

FIG. 3 is a perspective drawing showing the assembly of the principal components of a portable projection apparatus in keeping with the present invention;

FIG. 4 is a sketch showing the manner in which parallax between an object in the foreground and a background will be perceived from different viewpoints or by differing viewers; and

FIG. 5 is a perspective drawing similar to that shown in FIG. 3, except showing the placement of two film and projection device structures in tandem, one with the other.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

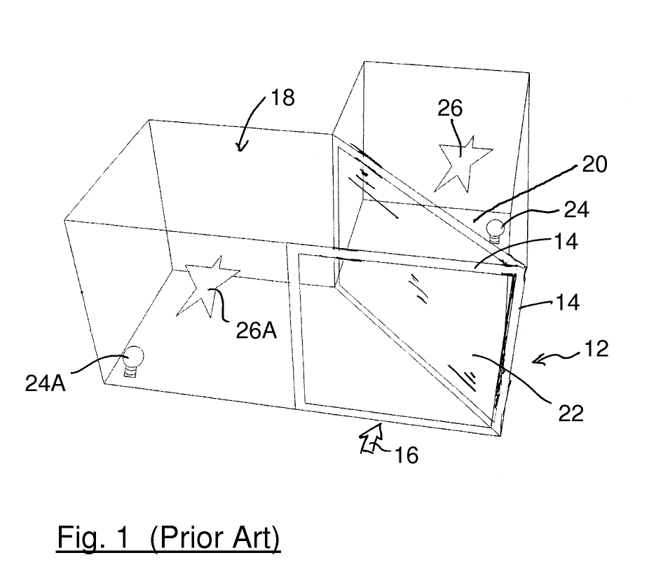

FIG. 1 is a sketch showing a classic arrangement by which the Pepper's ghost illusion was exhibited starting in the last half of the 19th century. A stage, typically a proscenium stage, is shown at 12 in FIG. 1, and has a proscenium 14. It will be seen that the left hand side of the stage is open; that is, there is no wall, wing drapery, or the like. However, a viewer looking at the stage 12 in the direction of arrow 16 sees nothing of the apparatus and setup at the left-hand side of the stage. Moreover, all of the structure at the left-hand side of the stage, commonly referred to as a Blue Room 18 (although it is usually black), is kept dark. That is, there is no illumination in the blue room 18, and the stage 20 is typically brightly lit so that whatever is behind the glass 22—which is set at an angle to the viewing direction 16—is clearly seen. There is no reflection seen on the front face of the glass 22 from the setting in the blue room 18. An object 24 is placed on the stage 20, and other props may also be placed. Another object 24A is placed in the blue room 18; and the entire blue room 18 is built as a mirror image of the scene which is set on the stage 20. Thus, any props or objects 24A that are set in the blue room 18 are arranged in mirror image to those which are seen on the stage 20 by the viewer. When illumination begins in the blue room 18, a reflection of what is in the blue room 18 is seen in the glass 22. Accordingly, a “ghost image” 26, of a second object 26A, which is located in the blue room 18, is reflected in the glass 22. If the second object 26A moves, the ghost image 26 will also be seen to move.

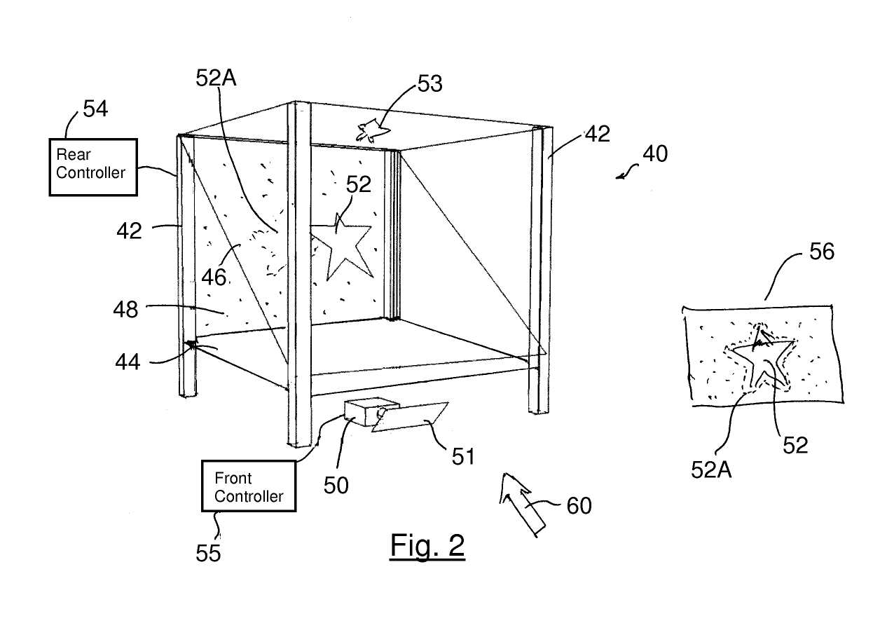

Turning now to FIG. 2, an illustration of a large scale installation which is in keeping with the principles of the present invention is seen at 40. The major components of this installation are a frame structure 42, a stage 44, a viewing film 46, a rear screen 48, and a television projector 50. The television projector is employed to project a virtual image 52, through an actual mirror 51 onto focus screen 53. The image on focus screen 53 is visible as it reflects off of viewing film 46, so as to appear as virtual image 52. Virtual image 52 acts as the first program material. The viewing film 46 is set at an angle with respect to the plane of the stage 44, and typically that angle may be in the range of 30° to 60°, more typically about 45°. It should also be noted that the viewing film 46 typically has a reflection factor in the range of 20% to 80%, and a transparency factor in the range of 80% to 20%.

A further rear screen projector (not shown) is employed to project second program material onto the rear screen 48, under the control of a rear controller or computer 54. Likewise, control of the projector 50 is effected by a front controller or computer 55. However, it is important to note that the virtual image 52, projected as the first program material, and the second program material seen on the back screen 48, are synchronized one with the other as shown at 56. As such, the two program material images are interrelated. The computer programming and the nature of the computers employed to effect that synchronization, however, are beyond the scope of the present invention.

Arrow 60 designates the direction from which a viewer will see the scene comprising the virtual image from the viewing film 46 and the rear screen 48. Any one particular viewer will see the images in the apparatus 40 in his own viewing plane, which will most likely be somewhat different from that of another viewer adjacent or behind or in front of the first viewer.

However, it will be noted that the viewing film 46 is angularly mounted with respect to the viewing plane of any viewer. Moreover, because the viewing film 46 is at least partially transparent and at least partially reflective, the virtual image 52 will be seen by any viewer, as well as any image which is projected onto the rear screen 48 due to the reflectance and transparency, respectively, of the viewing film 46. Obviously, the brightness and luminosity of the images on the viewing film 46 and rear screen 48 can be controlled, and thus, are also edited or synchronized so as to be interrelated, one to the other.

It should be noted though, that the virtual images seen from the viewing film 46 and the rear screen 48 will give rise to a perception of parallax between the image 52 and the image seen on the rear screen 48. Moreover, because of the synchronization 56 of the image 52 together with the image shown on the rear screen 48, the content aspects of the combined images can be controlled or modified for an enhanced viewing effect. For example, the virtual image 52 may be seen to move with respect to the image seen on the rear screen 48, and vice versa, as the viewer moves. It will be noted then, that with appropriate editing and computer control, any chosen first program material which is directed towards viewing film 46, and which is reflected therefrom due to the reflectancy of viewing film 46, aligns with an edited area 52A on the rear screen 48. As such, virtual image 52 will align with edited area 52A of the second program material image being seen on the rear screen 48. As a result, virtual image 52 will be in general alignment with the edited image on the plane of the rear screen 48, without any image from the second program material being superimposed on or under the projected virtual image.

A brief discussion of parallax, as that term is employed herein, is given with reference to FIG. 4. Here, viewpoint A is indicated at 70 and viewpoint B is indicated at 72. They may be considered to be either two positions which may be occupied by the same viewer as he moves from side to side, or positions being occupied by two different viewers. In any event, the viewer is looking at object 74 which is placed in front of a background that comprises three different image areas indicated 76, 78, 80. It will be seen that from viewpoint 70, the viewer will see the object 74 as if it is superimposed on the background area 80, as shown in the left side at the bottom of FIG. 4. Likewise, from viewpoint 72, the viewer will see the object 74 as if it is superimposed on the background area 76, as shown in the right side at the bottom of FIG. 4. Suppose now that the object 74 is the virtual image 52, and suppose that the background image areas 76, 78, 80, are different areas being projected onto the rear screen 48, as seen in FIG. 2. Now, if the viewer were to move sideways, that sideways motion will result in a different perceived image from each of viewpoints 70 and 72. This is an expression of parallax as it is found in the physical structure of any apparatus in keeping with the present invention, where the viewing film 46 is in front of and separated by a finite distance from the rear screen 48.

It will also be understood, of course, that either or both of the object 74, and the background image areas 76, 70, 80, can move with respect to one another; and that relative movement can be perceived to be in any direction including sideways, up or down, or forward a rearward, or any combination thereof.

Further, it can be noted that the perceived perception of the location of the virtual image can be modified. Depending on the depth of the apparatus, the virtual image can be perceived to be located in front of, co-planar with, or even behind, the rear screen. In the later case, inverse parallax can be simulated as part of the content aspect provided by the apparatus of the present invention.

Thus, it will be understood that with appropriate editing and computer control of the virtual image 52 and the image projected on the rear screen 48, an enhanced, simulated 3D viewing experience will be manifested. Therefore, the resulting parallax which occurs between virtual image 52 and the image projected on the rear screen 48, is much more than merely a by-product of images projected on the planes of the viewing film 46 and rear screen 48. Accordingly, skilful content creation methodology and computer programming methodology, all as are well known and which are beyond the scope of the present invention, may result in a nearly realistic visual experience.

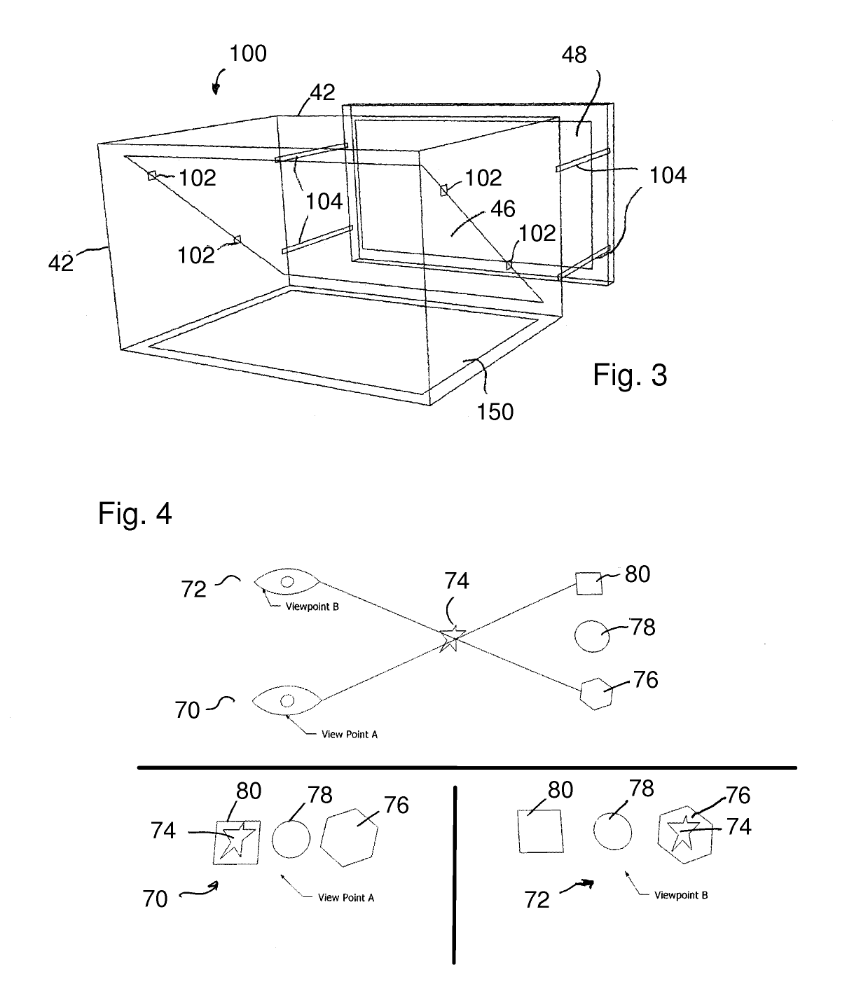

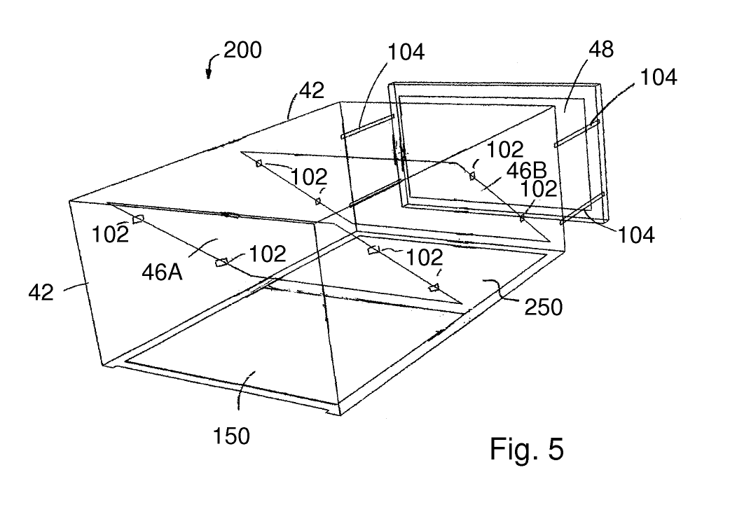

Turning now to FIG. 3, a self-contained, portable structure is seen at 100, and that structure includes all of the principal elements or components of the structure 40 as described above. The same reference numerals are employed in FIG. 3 (and in FIG. 5, described hereafter) as are employed in FIG. 2.

One distinct difference between the structure 100 and the structure 40 is that the viewing film 46 is sloped forwardly in the structure 100. This accommodates a first projector 150 placed in the bottom of the structure 100, and having a planar projection face. The projector 150 may be a planar television tube, but more particularly is a planar LED lit LCD television display. It may also be a planar LCD television display, a planar plasma television display, or a planar LED television display. The planar LED lit LCD television displays which are available in the market are brighter than the others, and in any event are light in weight.

Use of a television like screen is particularly preferred in this arrangement, since the virtual image directed onto viewing film 46 will be free from so-called keystone effects that would be caused by a central display device, and thus, correction of the keystone effect is not required.

Likewise, the rear screen 48 may be a planar television tube; but for purposes of lightness of weight and compactness of structure, a planar plasma television display, a planar LCD television display, a planar LED lit LCD television display, or a planar LED television display, are preferred.

Once again, the viewing film 46 typically comprises a metalized film, which may be a metalized polyester film or a metalized polymer film. In any event, that film is at least partially transparent as well as being at least partially reflective. As noted above, the metalized film which comprises the viewing film 46 preferably has a reflection factor in the range of 20% to 80%, and a transparency factor in the range of 80% to 20%. In a typical film, one of the front face or back face of the viewing film 46 is typically a metalized surface.

When the film is mounted within the frame 42, the viewing film 46 can be tensioned so as to be substantially wrinkle free, thereby permitting reflectance of an image projected from the projector 150 without distortion. The mounting of the viewing film 46 employs suitable anchors 102 that clamp the edges of the film. However, numerous methods for holding the film are known, and the exact nature of these devices is beyond the scope of the present invention.

Stanchions 104, or other suitable structural devices, are employed to provide appropriate spacing between the viewing film 46 and the rear screen 48. The length of the stanchions 104 will vary from structure to structure, because the structures 100 are scalable as to size. Stanchions 104 also allow rear screen 48 to be moved to a storage position wherein structure 100 is made smaller, and therefore, more easily moved.

Moreover, during use, rear screen 48 can be moved, with respect to viewing film 46, by movement of the rear screen 48 on stanchions 104. As such, the distance between the rear screen 48 and viewing film 46 can be modified depending on the nature of the images to be displayed. Thus, the depth of the structure, and thus the depth between the first and second program material (and thus parallax) desired for a given “scene” of synchronized images, can be modified during use, either statically, or dynamically, depending on the nature of the image.

To control the ambient lighting within structure 100, a stretchable fabric (not shown) or the like, can be affixed to the structure, and thus, prevent unwanted light from entering structure 100. In a preferred arrangement, structure 100 is closed with the exception of the viewing area.

Structure 100 can also be modified to house any and all computerized devices necessary to provide the first or second program material, and the like. Alternatively, these devices can be separately housed, and electrically connected to structure 100 using known connection devices.

Also, as noted above, adjustment of the capacity and luminance values of the image on the rear screen 48 compared to the capacity and luminance values of the image on the viewing film 46 will result in an improved image parallax and better image fidelity of the virtual image 52. Adjustment of the opacity of the image projected on to the rear screen 48 to the range of 20% to 40% of that of the opacity of the virtual image on viewing film 46 can result in a well perceived 3D effect.

Moreover, the use of traveling mattes, which are essentially artificial black masks that are “cut-outs” of imagery directed towards viewing film 46, when applied to the corresponding imagery projected onto the rear screen 48, results in an improved 3D effect. Of course, control of the black masks is in synchronization with the imagery being viewed on the viewing film 46.

The films that are used for purposes of the viewing films 46 are, as noted, typically metalized polymer film or metalized polyester film. These films may also be referred to as foils. In any event, the films must be substantially tear proof but capable of being tensioned so as to be made wrinkle free.

Referring now to FIG. 5, a structure 200 is shown. As before, similar reference numerals are employed to indicate the same or similar structural elements, as have been used above with respect to discussions concerning FIGS. 2 and 3. The significant difference between structures 100 and 200 is that the structure 200 comprises two viewing films 46A and 46B which are in tandem one with the other. Because those viewing films 46A and 46B will show different program material images, two projectors 150 and 250 are required. The viewer will thus observe a virtual image from film 46A, and a virtual image from film 46B. In this embodiment, the use of the rear screen 48 is preferred, but may be optional.

It has been mentioned above that one feature of a certain aspect of the present invention is that the portable projection apparatus is scalable and portable. That is, the apparatus may vary in size from perhaps that of a small television set to, say, that of a refrigerator, or even the size of a small trailer. In any event, each structure is self-contained, so that in effect its set up merely involves plugging it in to a suitable electrical receptacle. The structures 100 or 200 may be mounted to a wall using suitable mounting brackets, bolts, or other hardware; or the structures may be set down on a supporting surface such as a desk or table. If the structures are larger, they may, in fact, be placed on the ground as may be suggested in FIG. 2, or on a stage such as might be found in a theatre, conference center, or the like.

In practice, any portable projection apparatus in keeping with the present invention may find a number of uses. For example, in certain advertising or other theatrical presentations, the image which is directed towards viewing film 46 may be that of a product, a presenter, or an actor; and the image which is projected onto the rear screen 48 may be a very simple or subtle background. The resulting visualization is that of a floating product or person before a background which does not overwhelm the image of the product or person.

In some circumstances, both of the viewing film 46 and the rear screen 48 may be used to view a single object, scene, or effect. For example, a merry-go-round representation can be provided which may be seen to be coming forward, across, and backward with respect to the viewer, giving a very real 3D viewing experience. Another example is to show such as an explosion on the viewing film 46 with debris going away from the viewer.

Another example may be such as to give the impression that the virtual image 52 is inside an enclosure, and that the outside of the enclosure is seen on the rear screen. A film sequence, where the camera appears to be looking through the windshield of the car and out the back window of the car to the road behind, may be achieved where the holographic image on the front viewing film is the windshield of the car.

It is also possible to make images where an object appears to move from one plane to another. For example, a ball may be struck by a character whose image appears in the rear screen, with the ball appearing to come forward because of the holographic image from viewing film 46. The reverse sequence is also possible.

There has been described a portable projection apparatus which may, in some embodiments, be self-contained and scalable as to size. Moreover, any portable projection apparatus in keeping with the present invention will employ at least one planar viewing film which is sloped with respect to the viewing plane of any viewer, and of course also with respect to the planar rear screen. A virtual image is directed towards the viewing film with a background image being projected from another projector on to a rear screen and/or on to a second sloped viewing film. The nature of the viewing film is such that it is partially transparent and partially reflective, each in the range of about 20% to about 80%. Various projectors are proposed; and it is noted that the opacity and luminance values of the viewing film and rear screen may be varied.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially planar is intended to mean planar, nearly planar and/or exhibiting characteristics associated with a planar element.

Moreover, use of the terms “he”, “him”, or “his”, is not intended to be specifically directed to persons of the masculine gender, and could easily be read as “she”, “her”, or “hers”, respectively.

1. A portable projection apparatus which may be moved from one exhibition site to another, and which is scalable in size from one such apparatus to another, comprising:
a first projection device arranged to direct first program material towards a planar viewing film, wherein said viewing film has a front face and a back face, and is angularly mounted with respect to a viewing plane, and wherein said viewing film is at least partially transparent and at least partially reflective, whereby at least one viewer may view a reflected image of said first program material in said viewing plane, as a virtual image;
a second, rear screen arranged to exhibit second program material from a second projection device, and being oriented with respect to said viewing plane behind the back face of said viewing film;
wherein the first program material and the second program material are edited or synchronized one with the other so that said virtual image appears to be interrelated to said second program material on said rear screen, so as to provide a simulated 3D viewing experience.

2. The portable projection apparatus of claim 1, wherein said planar viewing film is made from a metalized film chosen from the group consisting of metalized polyester film and metalized polymer film.

3. The portable projection apparatus of claim 1, wherein said first projection device comprises at least one projection television apparatus having lamps and projection lenses.

4. The portable projection apparatus of claim 1, wherein said first projection device is chosen from the group consisting of a planar television tube, a planar plasma television display, a planar LCD television display, a planar LED lit LCD television display, and a planar LED television display.

5. The portable projection apparatus of claim 1, wherein said viewing film is sloped upwardly or downwardly, with respect to the viewing plane.

6. The portable projection apparatus of claim 5, wherein the angle at which the viewing film is sloped, with respect to the viewing plane, is in the range of 30° to 60°.

7. The portable projection apparatus of claim 6, wherein the angle at which the viewing film is sloped, with respect to the viewing plane, is in the range of 40° to 50°.

8. The portable projection apparatus of claim 1, wherein said first projection is upwardly with respect to said viewing plane, and said viewing film is sloped forwardly with respect to the viewing plane.

9. The portable projection apparatus of claim 2, wherein the planar viewing film has a reflection factor in the range of 20% to 80%, and a transparency factor in the range of 80% to 20%.

10. The portable projection apparatus of claim 1, wherein said rear screen is a screen for a rear projection television apparatus.

11. The portable projection apparatus of claim 1, wherein said rear screen is chosen from the group consisting of a planar television tube, a planar plasma television display, a planar LCD television display, a planar LED lit LCD television display, and a planar LED television display.

12. The portable projection apparatus of claim 1, wherein the synchronization of said first program material and said second program material is under the control of a computer which edits said first program material and/or said second program material.

13. The portable projection apparatus of claim 12, wherein the edited first program material and/or the edited second program material are edited in a manner so that any chosen first program material directed towards said viewing film will create a virtual image which will appear to align with an edited area of the second program material, which has been edited so that the virtual image appears in, on, or behind the plane of said rear screen without any image from the second program material being superimposed on or under said virtual image.

14. The portable projection apparatus of claim 13, wherein the editing and placement of the first program material and said edited area of said second program material are such that the chosen virtual image and said edited area of said second program material may be made to move in any direction from frame to frame of said respective first and/or second program material, and wherein the directions of movement from frame to frame of said virtual image and said edited area of said second program material are in opposite directions, so as to provide the illusion of movement one with respect to the other.

15. The portable projection apparatus of claim 1, wherein the editing and synchronization of said first program material and said second program material is under the control of a computer, and wherein at least one movable edited mask is placed directly in front of the rear screen so that any chosen virtual image appears in the plane of said rear screen without any image from the second program material being superimposed on or under the virtual image.

16. The portable projection apparatus of claim 1 additionally comprising at least one additional projection device arranged in front of said first projection device, and positioned to direct additional program material towards an additional planar viewing film, which is also angularly mounted with respect to a viewing plane, and wherein said viewing film is at least partially transparent and at least partially reflective, whereby at least one viewer may view said additional program material in said viewing plane, when directed towards said additional planar viewing film, as an additional virtual image.

17. The portable projection apparatus of claim 1, wherein said first and second projection devices, said viewing film, and said rear screen, are permanently mounted in a case so as to be portable as a single structure.

18. The portable projection apparatus of claim 17, wherein said rear screen is mounted on stanchions which allows movement of said rear screen, in said viewing plane, relative to said viewing film.

19. The portable projection apparatus of claim 1, wherein said rear screen is moved towards said viewing film to reduce the depth of the device, and cause said virtual image to be perceived to be behind said rear screen.
